(19) United States
(12) Patent Application Publication
(10) Pub. No.: US 2025/0380001 A1
(43) Pub. Date: Dec. 11, 2025

(54) Method for segmenting a plurality of data, and corresponding coding method, decoding method, devices, systems and computer program

(71) Applicant: ORANGE, Issy-les-Moulineaux (FR)

(72) Inventors: Félix Henry, Chatillon (FR); Marta Milovanovic, Chatillon (FR)

(21) Appl. No.: 18/876,914

(22) PCT Filed: Jun. 9, 2023
(86) PCT No.: PCT/EP2023/065446

§ 371 Date: Dec. 19, 2024

(30) Foreign Application Priority Data
Jun. 22, 2022 (FR) FR2206177

(51) Int. Cl. H04N 19/597; H04N 19/154; H04N 19/60

(52) U.S. Cl. CPC H04N 19/597; H04N 19/154; H04N 19/649

(57) ABSTRACT

A method for segmenting a plurality of input data. The method includes: determining weight values to be applied to the plurality of input data before it is processed by at least one processing device configured to produce a processing result according to a criterion for optimizing a quality of the processing result, depending on the criterion and on a criterion for optimizing a quantity of input data to be processed; determining segmentation information of the plurality of input data, assigned a first value or a second value, depending on the weights; and obtaining a subset of data to be processed by applying the segmentation information to the plurality of input data, including the data of the plurality of input data associated with an item of segmentation information equal to the first value.

### FIELD OF THE INVENTION

The present invention relates generally to the field of processing a plurality of data, such as multiview 3D images of a scene acquired by a plurality of cameras or physiological data of a patient obtained from a plurality of sensors.

The invention relates in particular to segmenting this plurality of data before it is coded and then transmitted via a communication network to a processing device.

### PRIOR ART

In the field of virtual reality and immersive video, free navigation allows the viewer to view a scene from any viewpoint, whether that viewpoint corresponds to a viewpoint captured by a camera or a viewpoint that has not been captured by a camera, using a device such as a virtual reality headset. Such a view that has not been captured by the camera is called a virtual view or an intermediate view because it lies between views captured by the camera and must be synthesised for rendering the scene to the viewer from the captured views.

In an immersive video context, that is, where the viewer has the feeling of being immersed in the scene, the scene SC is typically captured by a set of cameras, as illustrated in FIG. 1. These cameras can be of type 2D (cameras C₁, C₂ . . . C_{N}, with N a non-zero integer in FIG. 1), that is, each of them captures a view from one viewpoint, or of type 360, that is, they capture the entire scene 360 degrees around the camera (camera C₃₆₀ of FIG. 1), therefore from several different viewpoints. The cameras can be arranged in an arc, a rectangle, or any other configuration that provides good coverage of the scene.

In relation to FIG. 2, at a given time, a set of images representing the scene from different views is obtained. Since this involves videos, the captured images are time-sampled (30 images per second, for example) to produce an original multiview video VMV, as shown in FIG. 3.

The MIV (MPEG Immersive Video) standard enables the transmission of videos suitable for immersive navigation. The encoder chooses portions of each view (patches) that it wants to transmit in order to maximise the view synthesis quality from these patches, while reducing the quantity of data to be transmitted. The patches are extracted from the views and gathered in one or more atlases, which are therefore images comprising an assembly of patches from different views. Patches are generally arranged in an atlas so as to fill it as completely as possible. An occupancy map, which is an image in which each pixel can take a first or a second value, distinct from the first one (for example corresponding to the colour “white” or “black”) to indicate whether or not the pixel in the atlas belongs to a patch, is transmitted with each atlas. A segmentation of the patches in the atlas can thus be obtained from this occupancy map. In addition, other information is transmitted for each patch, comprising its coordinates in the atlas and the view with which it is associated.

From the data transmitted, the MIV decoder can find the patches and arrange them in the view to which they belong. This view is then referred to as “partial”, as it does not contain all the pixel values of the original view as acquired by one of the cameras. However, if the encoder has effectively selected the portions of views to be transmitted, they are sufficient to generate or synthesise any viewpoint of the scene. In this respect, the view synthesis from the decoded views is not specified by the MIV standard. It relies on the occupancy maps to determine whether or not a pixel of a given view contains a relevant item of information.

A method for texture-based view synthesis using neural networks is also known from the paper by Wang et al. entitled “IBRNet: Learning Multi-View Image-Based Rendering”, published by arXiv:2102.13090v2 in April 2021. In particular, the paper describes a neural network, referred to as IBRN, that takes as input the parameters of the cameras, the texture images captured from the various viewpoints, and the coordinates of the viewpoint of the scene to be synthesised, and produces as output the synthesised view, corresponding to the view that would have been captured by a camera from the viewpoint corresponding to the coordinates provided. One advantage of this method is that provides very good qualitative results.

One disadvantage of this method, and more generally of current view synthesis methods, is that they require all the views acquired by the cameras. This represents a large quantity of data to be transmitted and then decoded, which poses a complexity problem at the decoder, in particular when it is embedded in a mobile terminal such as a smartphone or an augmented reality headset.

There is therefore a need for a solution to reduce the quantity of data, and in particular the number of pixels to be transmitted, while preserving as much as possible the quality of the view synthesis.

The invention improves the situation.

### SUMMARY OF THE INVENTION

The invention responds to this need by proposing a method for segmenting a plurality of data acquired by sensors, referred to as input data, said method comprising:
determining weight values to be applied to the plurality of input data before it is processed by at least one processing device configured to produce a processing result according to a criterion for optimising a quality of the input data processing result, said weight values being determined depending on said criterion and on a criterion for optimising a quantity of input data to be processed,
determining segmentation information of said plurality of input data, one said item of segmentation information of one said item of data being assigned a first value or a second value distinct from the first one, depending on said weights, and
obtaining a subset of data to be processed by applying the determined segmentation information to said plurality of input data, the subset of data to be processed comprising the data of the plurality of input data associated with an item of segmentation information equal to the first value.

The invention proposes a completely new and inventive approach to segmenting a plurality of input data before it is processed by a given processing device, which consists in configuring weight values to be applied to the input data so that the quantity of data resulting from the segmentation and presented at the input of the processing device, as well as the processing quality, are both optimised. The values of the weights are determined from the plurality of input data itself, and are therefore specifically chosen for it.

For example, the criterion for optimising a quantity of input data to be processed comprises a minimisation of a cumulative value of the weight values or of a number of weight values below a given threshold. According to a variant, it comprises a minimisation of a cumulative value of the input data kept in the subset of data to be processed or of a number of these items of input data. For example, the criterion for optimising a quality of the processing comprises a minimisation of a square error between a result obtained from the plurality of input data and a result obtained from the subset of data to be processed, or yet a maximisation of a peak signal-to-noise ratio or PSNR.

The values of the weights of the configuration obtained are then used to determine one or more items of segmentation information of the plurality of input data. This segmentation information indicates:
which input data should be provided at the input of the processing device, because they are useful for it to produce a processing result compliant with the criterion for optimising a quality of the input data processing result, and
which input data should not be presented to the processing device, because they are not useful, in the sense that it does not contribute to improving the quality of the processing result obtained.

The segmentation information thus determined is used to obtain the subset of data to be processed. In this way, only this subset of data to be processed can be coded and transmitted to a receiver incorporating a similar processing device in terms of structure and configuration.

Thus, the invention does not only propose to perform an efficient segmentation of the plurality of input data, but also takes into account, when determining the values of the weights that perform the segmentation, the impact of the values of the weights of the segmentation module, that performs the segmentation, on the output of the processing device. It therefore does not consider a simple segmentation module independent of the processing device, but takes into account the combination of both, and more precisely, their successive actions on the input data.

The invention applies to any type of data acquired by any type of sensor. For example, a plurality of sensors is arranged around a scene, an object or a subject . . . . It involves for example a plurality of cameras, each with distinct viewpoints of the scene and configured to acquire a sequence of images or views of this scene. In this case, the processing device can be a device for synthesising additional views from the original views acquired by the plurality of cameras and the segmentation of the original views according to the invention means that only the data useful for synthesising an additional view are kept and redundant data are eliminated.

According to another example, the plurality of data consists in time sequences of physiological measurements of a patient captured by a plurality of sensors of various types (ElectroCardioGram (ECG), ElectroEncephaloGram (EEG), scanner, magnetic resonance imaging (MRI), X-ray image, blood composition indicator, etc.). In this other example, the processing device can be a diagnosis assistance device.

According to another aspect of the invention, the determination comprises a learning of said weight values from said plurality of input data, said learning being performed by backpropagation of a gradient of a loss function combining the two criteria.

Advantageously, the determination of the weight values performing the segmentation of the input data implements a learning technique of an artificial intelligence module using the plurality of input data itself. More specifically, the artificial intelligence module, referred to hereinafter as a segmentation module, learns the best possible internal configuration of its weights, both optimising the quantity of data of the subset of input data to be presented at the input of the processing device and optimising the data processing quality.

The invention goes against usual practice in terms of machine learning, in that it implements a learning specific to a plurality of given input data. Thus, it does not require the prior acquisition of a large base of labelled learning data, but only the plurality of current data to be processed.

According to yet another aspect of the invention, said processing device comprises weights, referred to as processing weights, values of said processing weights have been previously determined depending on the criterion for optimising the quality of the input data processing result, and the method further comprises determining modified values of said processing weights.

Advantageously, the processing device also implements an artificial intelligence technique, based on the application of weights to the input data. For example, this processing device has previously been trained, in the conventional way, from a base of labelled data, to process the plurality of input data so as to provide as output a result compliant with the criterion for optimising the quality of the processing.

Advantageously, the learning according to the invention is a combined learning of the segmentation module and the processing device. It includes updating the configuration of the processing device so that it can optimally process the subset of data resulting from the segmentation of the plurality of input data.

For example, the segmentation module and the processing device are each organised in layers comprising weights and the succession of their respective layers forms an artificial intelligence module, for example a neural network, trained to segment the input data and then process them optimally.

According to yet another aspect of the invention, said plurality of input data comprises a plurality of views acquired by a plurality of cameras, one said view comprises pixels, said weights are comprised in a plurality of layers, one said layer is associated with one said view and comprising one said weight per pixel, and the segmentation information comprises a plurality of segmentation maps, one said map being associated with one said view.

The invention is particularly applicable to input data of the multiview video sequence type. Advantageously, a segmentation module structured in layers, with one layer per view and one weight per pixel, the weights of each layer making it possible to derive the item of segmentation information of the pixels of the associated view, is considered.

For example, for images captured by cameras, the segmentation information can take the form of segmentation maps, of the same dimensions as the input images, and whose useful pixels are assigned a first value (for example, corresponding to “white”) and non-useful pixels a second value (for example, corresponding to “black”).

Advantageously, the processing device is configured to synthesise an additional view associated with a given viewpoint from at least one original view it receives as input.

It is understood that in this case, the learning according to the invention can consist in presenting at the input of the segmentation module, combined with the processing device, the plurality of acquired views except for one which will be the one to be synthesised. In this way, the loss function can be calculated by comparing the synthesised view with the original view. Advantageously, this procedure will be repeated for each of the acquired views.

According to another aspect of the invention, said plurality of input data comprises a plurality of sequences of measurement data acquired by a plurality of sensors, said weights are comprised in a plurality of layers, one said layer is associated with one said sequence of measurement data and comprises one said weight per item of measurement data, and the segmentation information comprises a plurality of segmentation sequences, one said segmentation sequence being associated with one said sequence of measurement data.

According to this other example, the plurality of data consists of time sequences of physiological measurements of a patient captured by a plurality of sensors of various types. In this other example, the processing device can comprise one or more diagnosis assistance devices.

Correlatively, the invention also relates to a device for segmenting a plurality of data acquired by sensors, referred to as input data, said device being configured to implement:
determining weight values to be applied to the plurality of input data before it is processed by at least one processing device configured to produce a processing result according to one criterion for optimising a quality of the input data processing result, said weight values being determined depending on said criterion and on a criterion for optimising a quantity of input data to be processed,
determining segmentation information of said plurality of input data, one said item of segmentation information of one said item of data being assigned a first value or a second value distinct from the first one, depending on said weights, and
obtaining a subset of data to be processed by applying the determined segmentation information to said plurality of input data, the subset of data to be processed comprising the data of the plurality of input data associated with an item of segmentation information equal to the first value.

The above-mentioned device implements the segmentation method according to the invention in its various embodiments.

Advantageously, said segmentation device is integrated into an item of server equipment configured to receive the plurality of input data and further comprising the above-mentioned device for processing the plurality of input data.

The invention also relates to a method for coding a plurality of data acquired by sensors, referred to as input data, comprising:
obtaining segmentation information of the plurality of input data and a subset of data to be processed by applying said segmentation information to the plurality of input data, said segmentation comprising the determination of weight values to be applied to the plurality of input data before it is processed by at least one processing device previously configured to produce a processing result depending on a criterion for optimising a quality of the processing, said weight values being determined depending on said criterion and on another criterion for optimising a quantity of input data to be processed, one said item of segmentation information of one said item of data being assigned a first or a second value distinct from the first one, depending on said weight values, the subset (USS) of data to be processed comprising the data of the plurality of input data associated with an item of segmentation information equal to the first value, and
coding the segmentation information and the subset of data to be processed.

With the invention, the coded data contain all the information to reconstruct a plurality of segmented input data at a receiver comprising a processing device similar to that implemented by the transmitter, in terms of structure and configuration.

According to another aspect of the invention, the obtaining further comprises:
obtaining modified weight values, said weights being intended to be applied to the input data by the processing device, values of said weights previously determined depending on said criterion for optimising a quality of the input data processing result and for processing the plurality of input data, having been modified depending on said criteria, for processing the subset of data to be processed,
coding said modified weight values.

Advantageously, the invention proposes to transmit in the coded data the modified weight values of the processing device on the transmitter side, with a view to updating the configuration of the processing device on the receiver side. This ensures that the processing device produces an optimum result in the sense of the optimisation criterion.

Correlatively, the invention also relates to a device for coding a plurality of data acquired by sensors, referred to as input data, configured to implement:
obtaining segmentation information of the plurality of input data and a subset of data to be processed by applying said segmentation information to the plurality of input data, said segmentation comprising the determination of weight values to be applied to the plurality of input data before it is processed by at least one processing device previously configured to produce a processing result depending on a criterion for optimising a quality of the processing, said weight values being determined depending on said criterion and on another criterion for optimising a quantity of input data to be processed, one said item of segmentation information of one said item of data being assigned a first or a second value distinct from the first one, depending on said weight values, the subset of data to be processed comprising the data of the plurality of input data associated with an item of segmentation information equal to the first value, and
coding the segmentation information and the subset of data to be processed.

The above-mentioned device implements the coding method according to the invention in its various embodiments.

Advantageously, said coding device is integrated into the above-mentioned item of server equipment.

The invention also relates to a method for decoding coded data, comprising:
decoding coded data, said coded data comprising segmentation information of a plurality of data acquired by sensors, referred to as input data, a subset of data to be processed by a processing device configured to apply weights to the plurality of decoded input data and to produce a processing result depending on a criterion for optimising a quality of the processing, one said item of segmentation information of one said item of input data being assigned a first value or a second value distinct from the first one, said subset of data to be processed having been obtained by applying said segmentation information to the plurality of input data, the subset of data to be processed comprising the data of the plurality of input data associated with one said item of segmentation information equal to the first value, said coded data further comprising modified values of said weights, said modified values having been determined for processing the plurality of segmented input data, depending on the criterion for optimising a quality of the processing and on a criterion for optimising a quantity of data of the subset of data to be processed,
constructing a plurality of decoded segmented input data from the subset of decoded data to be processed and the decoded segmentation information, and
providing the plurality of decoded segmented input data and the modified values of said weights to the processing device.

Advantageously, the invention proposes to code the modified weight values of the processing device on the transmitter side, with a view to transmitting them to a receiver and updating the configuration of the processing device on the receiver side. This ensures that the processing device produces an optimum result in the sense of the optimisation criterion.

Correlatively, the invention also relates to a decoding device comprising:
decoding coded data, said coded data comprising segmentation information of a plurality of data acquired by sensors, referred to as input data, a subset of data to be processed by a processing device configured to apply weights to the plurality of decoded input data and to produce a processing result depending on a criterion for optimising a quality of the processing, one said item of segmentation information of one said item of input data being assigned a first value or a second value distinct from the first one, said subset of data to be processed having been obtained by applying said segmentation information to the plurality of input data, the subset of data to be processed comprising the data of the plurality of input data associated with one said item of segmentation information equal to the first value, said coded data further comprising modified values of said weights, said modified values having been determined for processing the plurality of segmented input data, depending on the criterion for optimising a quality of the processing and on a criterion for optimising a quantity of data of the subset of data to be processed,
constructing a plurality of decoded segmented input data from the subset of decoded data to be processed and the decoded segmentation information, and
providing the plurality of decoded segmented input data and the modified values of said weights to the processing device.

The above-mentioned device implements the decoding method according to the invention in its various embodiments.

Advantageously, said decoding device is integrated into an item of terminal equipment configured to receive the coded data and further comprising the above-mentioned processing device.

The invention also relates to a signal carrying coded data. Said coded data comprises segmentation information of a plurality of data acquired by sensors, referred to as input data, a subset of data to be processed obtained by applying said segmentation information to said plurality of input data, one said item of segmentation information of one said item of input data being assigned a first value or a second value distinct from the first one, the subset of data to be processed comprising the data of the plurality of input data associated with an item of segmentation information equal to the first value, said subset of data to be processed being intended to be decoded and then used to reconstruct a plurality of decoded segmented input data from the decoded segmentation information, with a view to the processing of said plurality of segmented input data by a processing device, configured to produce a processing result depending on a criterion for optimising a quality of the processing, by applying weights to the plurality of input data. Said coded data further comprises modified values of said weights, said modified values having been determined for the processing of the plurality of segmented input data, depending on the criterion for optimising a quality of the processing and on a criterion for optimising a quantity of data of the subset of data to be processed, and being intended to be used by said processing device to update said weights prior to the processing of the plurality of reconstructed decoded segmented input data.

The invention also relates to a system comprising the segmentation device, the coding device, the decoding device and the above-mentioned processing device. This system and the segmentation, coding and decoding devices according to the invention have at least the same advantages as those conferred by the above-mentioned methods.

The invention finally relates to computer program products comprising program code instructions for implementing respectively the above-mentioned segmentation, coding and decoding methods, when they are executed by a processor.

Such a program can use any programming language, and can be in the form of source code, object code, or intermediate code between source code and object code, such as in a partially compiled form, or in any other desirable form.

The invention also relates to a computer-readable storage medium on which are saved the computer programs comprising program code instructions for implementing the steps of the methods according to the invention as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer programs contained therein can be executed remotely. The programs according to the invention can be downloaded in particular on a network, for example the Internet network.

Alternatively, the storage medium or media can be one or more integrated circuits in which the program is embedded, the circuit(s) being adapted to execute or to be used in the execution of the above-mentioned methods.

According to one embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or a service, whether individually or in combination.

In the same way, a hardware component is any element of a hardware assembly capable of implementing a function or set of functions, as described below for the module concerned. It may be a programmable hardware component or a component with an integrated processor for executing software, for example, an integrated circuit, a smart card, a memory card, an electronic card for executing firmware, etc.

Each component of the system described previously naturally implements its own software modules.

The various embodiments mentioned above can be combined with each other for the implementation of the present technique.

### BRIEF DESCRIPTION OF THE DRAWINGS

Other characteristics and advantages of the present invention will emerge from the description below, with reference to the annexed drawings which illustrate a non-restrictive embodiment thereof. In the figures:

FIG. 1: shows an example of the arrangement of a plurality of cameras forming a system for acquiring a multiview video of a scene, according to the prior art;

FIG. 2: diagrammatically illustrates a plurality of images of the scene, captured by the plurality of cameras at a given time, according to the prior art;

FIG. 3: diagrammatically illustrates a sequence of the plurality of images, captured by the plurality of cameras at several successive times and forming the original multiview video, according to the prior art;

FIG. 4: diagrammatically illustrates a first example of the architecture of a system according to one embodiment of the invention comprising a device for segmenting a plurality of input data, a device for coding segmentation information and a subset of data to be processed resulting from the segmentation, a device for decoding coded data representative of the subset of data to be processed and associated segmentation information and a device for processing the decoded data, when the plurality of data is a multiview video of the scene acquired by a plurality of cameras;

FIG. 5: diagrammatically illustrates a second example of the architecture of a system according to one embodiment of the invention comprising a device for segmenting a plurality of input data, a device for coding segmentation information and a subset of data to be processed resulting from the segmentation, a device for decoding coded data representative of the subset of data to be processed and associated segmentation information and a device for processing the decoded data, when the plurality of data comprises physiological measurements of a patient acquired by a plurality of sensors;

FIG. 6: describes in the form of a flowchart the steps of a method for segmenting a plurality of input data, according to one embodiment of the invention;

FIG. 7: describes in the form of a flowchart the steps of a method for coding data resulting from the segmentation of the plurality of coded data according to one embodiment of the invention;

FIG. 8: describes in the form of a flowchart the steps of a method for decoding data resulting from the segmentation of the plurality of data according to one embodiment of the invention;

FIG. 9: details a first embodiment of the above-mentioned segmentation and coding methods when the plurality of data comprises a multiview video;

FIG. 10: details a first embodiment of the above-mentioned decoding method when the plurality of input data comprises a multiview video;

FIG. 11: details a second embodiment of the above-mentioned segmentation and coding methods when the plurality of input data comprises a plurality of sequences of physiological measurements of a patient;

FIG. 12: details a second embodiment of the above-mentioned decoding method when the plurality of input data comprises a plurality of sequences of physiological measurements of a patient;

FIG. 13: describes an example of the hardware structure of a device for segmenting a plurality of data according to the invention;

FIG. 14: describes an example of the hardware structure of a device for coding a plurality of data according to the invention; and

FIG. 15: describes an example of the hardware structure of a device for decoding data resulting from the segmentation and the coding according to the invention.

### DESCRIPTION OF THE INVENTION

The principle of the invention is based on the segmentation of a plurality of input data, acquired by sensors arranged around a scene, an object or a subject, with a view to their processing by a given processing device. Segmentation refers here to identifying among the plurality of input data those to be kept for a given subsequent processing and gathering them into a subset of data to be processed.

In other words, it consists in pruning data from one or more of these sensors when it is not useful or relevant for the performance of the processing provided for by the processing device, for example because they are redundant with those acquired by one or more other of these sensors. According to the invention, the decision to prune or keep the input data is made based on two criteria, a criterion for optimising a quantity of segmented data, that is kept in the subset of data to be processed, and a criterion for optimising a quality of the given processing from the subset of data to be processed.

According to one embodiment of the invention, the segmentation is implemented by an artificial intelligence module placed upstream of the processing device and capable of configuring itself by machine learning. The structure of the automatic segmentation module comprises a plurality of weights intended to be applied to the plurality of input data and the learning of a configuration of the automatic segmentation module consists for the module in learning the best possible internal configuration of its weights, both minimising the quantity of data of the subset of input data to be presented at the input of the processing device and maximising the data processing quality.

According to the invention, this learning is on the one hand specific to the plurality of input data and on the other hand performed considering the result of the combination of the actions of the segmentation module and the processing device placed downstream of the segmentation module, that therefore recovers as input the plurality of data weighted by the configuration weights of the automatic segmentation module, according to at least two criteria. The first performance criterion relating to the segmentation module is to minimise a quantity of data to be provided to the processing device, which means pruning the plurality of input data as much as possible. The second performance criterion is linked to the processing device and requires a quality measurement of the processing performed by the processing device to be maximised.

The configuration values of the automatic segmentation module are then used to determine segmentation information of the plurality of data and a subset of data to be processed is finally obtained by applying the segmentation information to the plurality of input data.

The invention thus reduces the quantity of data to be coded and transmitted to a remote item of receiver equipment in which a processing device similar to those implemented by an item of transmitter equipment is embedded, while preserving the quality of this data processing.

The invention applies to any type of input data and is independent of the artificial intelligence technique implemented by the automatic segmentation module, provided that it can be configured using a plurality of configuration weights associated with the plurality of input data.

The invention has a particular application in a system for free navigation within a multiview video, for example embedded in an item of terminal equipment, such as a mobile phone or a virtual reality headset. In this case, the processing comprises the synthesis of an additional view, desired by the user of the item of terminal equipment, from the segmented data.

Of course, the invention is not limited to this use case, but can be applied to any other plurality of data acquired by sensors, such as sensors for physiological measurements of a patient.

In the following, embodiments of the invention are described for these two particular use cases.

Hereinafter, “scene” refers in the broadest sense to any object, subject or plurality of objects or subjects in their environment.

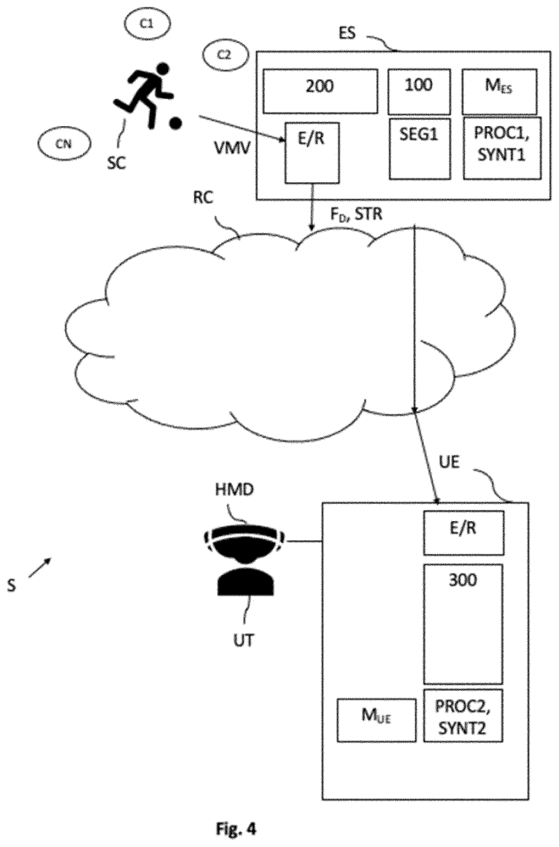

In relation to FIG. 4, an example of the architecture of a system S according to the invention, comprising an item of server equipment ES configured to receive input data acquired by a plurality of sensors C1, C2, . . . CN is now presented. In this case, it consists in a plurality of cameras and the input data received is a plurality of video sequences taken from different viewpoints of a scene SC, also referred to as multiview video VMV.

In this example, the item of server equipment ES comprises a transmission-reception module E/R, a segmentation device 100 according to the invention, a device for processing PROC1, SYNT1 the plurality of input data and a device for coding 200 the segmented data according to the invention. Such an item of server equipment ES is configured to transmit coded data, for example in the form of a data stream STR or a file FD, using its E/R module. It also comprises a memory MES in which it stores the coded data, for example.

According to the invention, the segmentation device 100 is configured to determine weight values to be applied to the plurality of input data before it is processed by at least one processing device (PROC1, SYNT1) configured to produce a processing result according to a criterion for maximising a quality measurement of the input data processing result, said weight values being determined depending on said criterion and on another criterion for minimising a quantity of input data to be processed, determine segmentation information of said plurality of input data, one said item of segmentation information of one said item of data being assigned a first value or a second value different from the first one, depending on said weights, and obtain a subset of data to be processed by applying the determined segmentation information to said plurality of input data, the subset of data to be processed comprising the data of the plurality of input data associated with an item of segmentation information equal to the first value.

In this example, the system S comprises an artificial intelligence module or segmentation module SEG1 comprising said weights and located upstream of the processing device PROC1, SYNT1. Advantageously, the determination comprises learning said weight values from said plurality of input data by backpropagation of a gradient of a loss function combining the two criteria.

As a variant, the module SEG1 is integrated into the device 100.

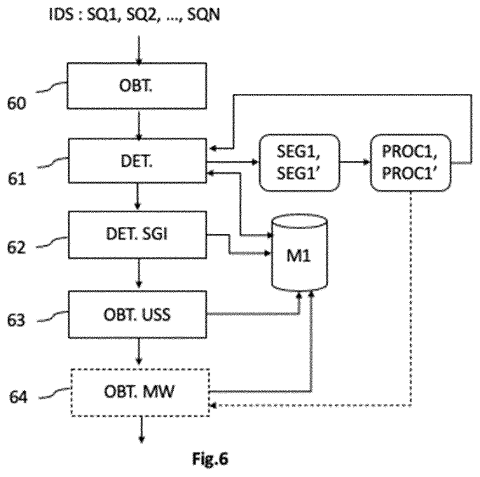

The device 100 thus implements the method for segmenting a plurality of data representative of a scene according to the invention that will be detailed hereafter in relation to FIG. 6.

According to the invention, the coding device 200 is configured to obtain segmentation information of the plurality of data and the subset of data to be processed produced by the segmentation device 100 and to code the subset of data to be processed and the segmentation information obtained. In FIG. 4, the device 100 is independent of the device 200, but according to one variant (not shown), it is integrated into the device 200.

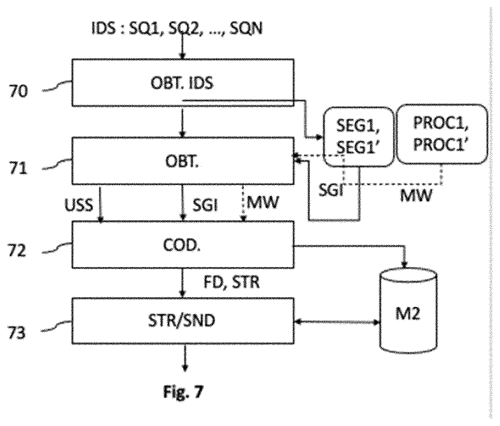

The device 200 thus implements the method for coding data representative of a scene according to the invention that will be detailed hereafter in relation to FIG. 7.

In this example, the processing device PROC1, SYNT1 is configured to synthesise a view selected by a user from the decoded input views, when it does not correspond to any of the views of the multiview video that have been transmitted in the coded data stream or file STR, FD. It is understood that according to the invention, the processing device PROC1, SYNT1 implemented in the item of server equipment ES is used only for learning purposes for the automatic segmentation module SEG1.

In this example, the system S also comprises an item of terminal equipment UE, for example a smartphone or an augmented reality headset, for example of the head-mounted device (HMD) type worn by a user UT, at a distance of the item of server equipment ES and for example connected to it via a communication network RC.

According to the invention, the item of terminal equipment UE comprises a transmission/reception module E/R, capable of receiving the coded data stream or file STR, FD via the communication network RC, a device 300 for decoding the coded data received, a device for processing PROC2, SYNT2 the segmented data, similar to that of the item of equipment ES, in terms of structure and configuration, and a memory M_{UE}.

In this example, the device 300 is configured to decode the coded data received and make it available to the processing device PROC2, SYNT2. According to the invention, the coded data comprise the segmentation information of the plurality of input data (here, the multiview video VMV) and the subset of data to be processed, resulting from the application of the determined segmentation information to said plurality of input data, produced by the device 100 of the item of equipment ES, as previously described.

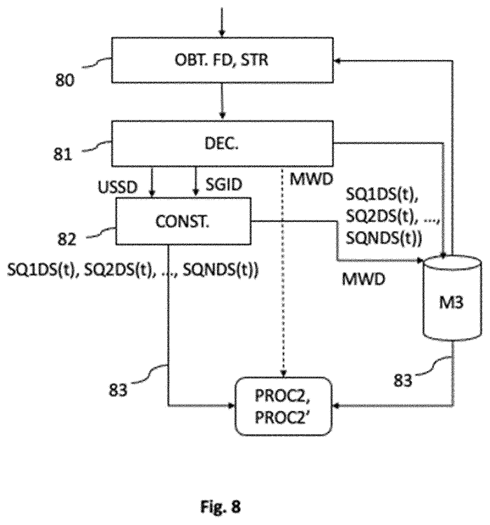

The device 300 thus implements the decoding method according to the invention that will be detailed hereafter in relation to FIG. 8.

In the example of FIG. 4, the processing device PROC2, SYNT2 of the item of terminal equipment UE is therefore configured to synthesise a view selected by a user from the other decoded views of the multiview video, when it does not correspond to any of the views of the multiview video transmitted in the coded data stream or file STR, FD. It is similar to the device PROC1, SYNT1 of the item of server equipment ES, in that it has the same structure and the same configuration. In a particular embodiment, the processing devices PROC1, PROC2 also comprise an artificial intelligence module comprising a weight structure whose values are configured using a machine learning technique. According to this embodiment, the prior configuration of the two processing devices PROC1, PROC2 (ES and UE sides) is automatically learned from the same base of input data, for example labelled, and under the constraint of a criterion for maximising a quality measurement of the processing result.

The memory M_{UE} is used, for example, to store the additional view synthesised by the processing device PROC2, SYNT2.

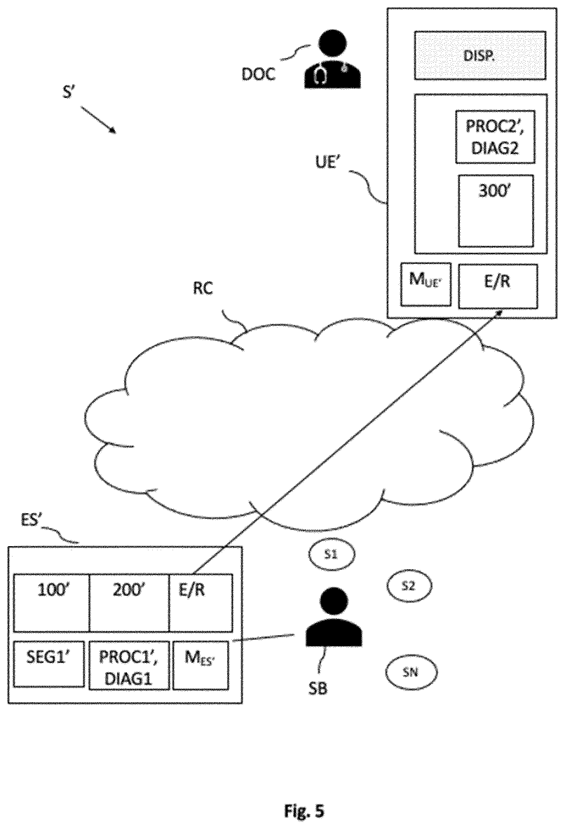

In relation to FIG. 5, another example of the architecture of a system S′ according to the invention, comprising an item of server equipment ES′, configured to receive input data acquired by a plurality of sensors S1, S2, . . . SN of various types, for example ECG, EEG, scanner, MRI, blood composition analysis, radio, etc. is now presented. In this case, it consists in a plurality of physiological sensors placed on or near a patient SB and the input data received is a plurality of sequences of physiological measurements acquired at different successive instants by the plurality of sensors. According to this example, the item of server equipment ES' has a structure similar to that of the item of server equipment ES previously described in relation to FIG. 4. It comprises a device 100′ for segmenting the plurality of physiological measurements according to the invention, a module for segmenting SEG1′ the input data, configured by the device 100′ to segment the input data according to the invention, a device for processing PROC1′, DIAG1 the data resulting from the segmentation by the module SEG1′, a device 200′ for coding the segmented data according to the invention, a transmission/reception module E/R and a memory MES′. The devices 100′ and 200′ are similar to the above-mentioned devices 100 and 200. The device 100′ thus implements the method for segmenting input data (here, physiological measurements of the patient SB) according to the invention that will be detailed hereafter in relation to FIG. 6. The device 200′ thus implements the method for coding input data according to the invention that will be detailed hereafter in relation to FIG. 7.

In this example, the processing device PROC1′, DIAG1 is configured to process the physiological measurements provided by the sensors in order to perform a diagnosis assistance processing. It is understood that according to the invention, on the item of server equipment ES' side, this processing device PROC1′, DIAG1 is only used here to configure the segmentation module SEG1′ of the device 100′ according to the invention.

The system S′ also comprises an item of terminal equipment UE′, at a distance of the item of server equipment ES' and connected to it via the communication network RC. The item of server equipment UE′ has a structure similar to that of the item of terminal equipment UE previously described in relation to FIG. 4. It comprises at least one decoding device 300′ similar to the decoding device 300 mentioned above in relation to FIG. 4, a processing device PROC2′, DIAG2 previously configured to process the plurality of data resulting from the sensors once decoded by the decoding device 300′, a transmission/reception module E/R and a memory MUE′. The device 300′ is similar to the above-mentioned device 300 and implements the method for decoding data representative of a scene according to the invention that will be detailed hereafter in relation to FIG. 8. Advantageously, it further comprises a display device DISP, for example of the screen type, that is used by a user DOC to view the physiological measurements received and decoded by 300′.

In relation to FIG. 6, an example of implementing a method for segmenting a plurality of input data according to one embodiment of the invention is now presented in the form of a flowchart. Advantageously, this method is implemented by the above-mentioned device 100 or 100′. SQ1(t), SQ2(t), . . . , SQN(t), where N is a non-zero integer, refers here to N time sequences of data acquired by N sensors placed around the object, subject or scene of interest at Nt successive time instants, where Nt is a non-zero integer, for example the scene SC or the patient SB of FIGS. 4 and 5. It is assumed that the N sequences are obtained in 60. In 61, the weight values of a segmentation module SEG1 (resp. SEG1′), to be applied to the input data are determined. For example, the module SEG1 (resp. SEG1′) is an artificial intelligence module capable of learning, from the input data SQ1(t), SQ2(t), . . . , SQN(t), those that are useful to a processing device PROC1 (resp. PROC1′) located downstream (the output of the module SEG1 (resp. SEG1′) is connected to the input of the processing device PROC1 (resp. PROC1′)) and previously configured to apply a predetermined processing to the plurality of input data, and those that are not. According to the invention, the segmentation module SEG1 (resp. SEG1′) is structured so as to apply weights to the plurality of input data, whose value is determined during this learning. Advantageously, the segmentation module SEG1 (resp. SEG1′) comprises as many weights as input data. These weights have, for example, floating values between 0 and 1 and their application (multiplication) to the value of an item of input data has the effect of keeping this item of data “on” or “off” before it is taken into account by the processing device PROC1 (resp. PROC1′).

For example, in a particular configuration of the automatic segmentation module SEG1 (resp. SEG1′), these weights are distributed in successive layers associated with each of the N sequences of input data at each of the Nt instants of each sequence. For example, when the input sequences are image sequences, the module SEG1 comprises N×Nt layers, with one layer per image or view and per time instant t, whose dimensions correspond respectively to those of the images of the N sequences.

According to the invention, the learning takes place based on a first performance criterion of the segmentation module SEG1 (resp. SEG1′), which is here a criterion for optimising a quantity of data to be presented to the processing device PROC1 (resp. PROC1′), but also based on a second performance criterion, specific to the processing device PROC1 (resp. PROC1′) itself, which is a criterion for optimising a quality of the processing. This consideration of the combination of the two successive processing operations and the fulfilment of these two performance criteria ensure that the pruning of input data by the segmentation module SEG1 (resp. SEG1′) is not detrimental to the performance of the processing device PROC1 (resp. PROC1′).

For example, the first criterion comprises a minimisation of an amplitude of the cumulative values of the weights of the segmentation module SEG1, SEG1′ layers. According to a variant, it comprises a minimisation of a number of weight values above a given threshold in said layers or a maximisation of a number of weight values below said threshold. According to yet another variant, it comprises a minimisation of the entropy of the input data at the output of the segmentation module SEG1, SEG1′, that is once the values of the weights of said layers have been applied to them. According to another variant, it comprises a minimisation of an amplitude of the cumulative values of the input data kept in the subset of data to be processed. According to yet another variant, it comprises a minimisation of a number of input data kept in the subset of input data to be processed. According to yet another variant, it comprises a minimisation of an entropy of the input data values kept in the subset of input data to be processed. Of course, the first criterion can also comprise a combination of several of these various criteria.

In 62, segmentation information SGI of the input data is determined from the weight values determined for module SEG1 (resp. SEG1′). For an item of input data, the corresponding item of segmentation information SGI is set to a first or to a second value distinct from the first one, depending on the value of the corresponding weight. For example, the first value is higher than the second value. The value of the weight is compared with a given threshold. When the value of the weight is above the threshold, the item of segmentation information is assigned the first value (which means “useful”, therefore “on”), and otherwise the second value (which means “useless”, therefore “off”). For example, for input data of the image type of dimension width W×height H, the segmentation information associated with this image comprises a segmentation map of the same dimension WxH, therefore the pixels are assigned a grey level corresponding to “white” when they correspond to data decided to be “useful” and at a grey level corresponding to “black” otherwise. As a variant, the first value is equal to 1 and the second one is zero. Segmentation information SGI is stored in a memory M1.

In 63, a subset of data to be processed USS is obtained by applying the segmentation information to the plurality of input data SQ1, SQ2, . . . , SON and keeping only those that are associated with an item of segmentation information assigned the first value. For example, the subset of data to be processed USS is stored in the memory M1 and can be provided to an encoder.

Optionally, according to a particular embodiment of the invention, the processing device PROC1 (resp. PROC1′) also comprises an artificial intelligence module having a layer structure comprising processing weights. It is assumed that it has been previously trained, using a learning base and in a manner known per se, to process input data of the type of the N time sequences SQ1(t), SQ2(t), . . . , SQN(t), according to the criterion for maximising a processing quality measurement. It is therefore assumed that the values of its processing weights have already been determined during this prior learning.

According to a first embodiment of the invention, the processing weights of the processing device PROC1 (resp. PROC1′) are fixed, that is, their values are not modified by the determination 61.

According to a second embodiment of the invention, the determination 61 also applies to the processing device PROC1 (resp. PROC1′) and has the effect of modifying the values of its processing weights. The modified processing weight values MW are obtained in 64. They are provided to an encoder or stored in the memory M1.

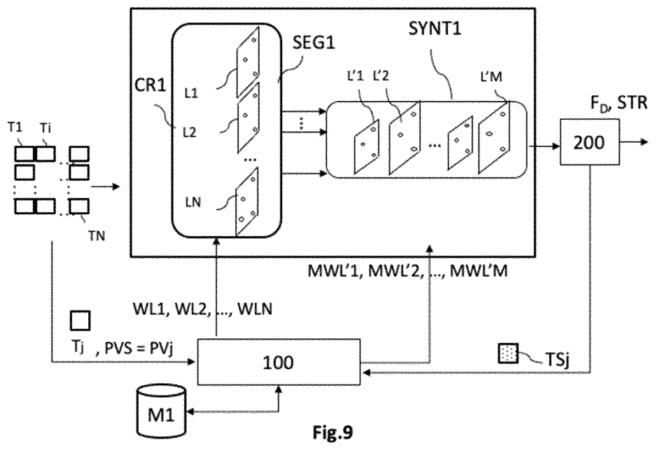

Embodiments of the invention in particular use cases will be detailed below in relation to FIGS. 9 to 11.

In relation to FIG. 7, an example of implementing a method for coding a plurality of input data according to one embodiment of the invention is now presented in the form of a flowchart. Advantageously, this method is implemented by the above-mentioned device 200 or 200′.

In 70, the device 200, 200′ obtains N time sequences of input data SQ1(t), SQ2(t), . . . , SQN(t), with N a non-zero integer, acquired by N sensors placed around the object, subject or scene of interest. In 71, it obtains a segmentation of this data performed by the segmentation method according to the invention that has just been described in relation to FIG. 6. It is assumed that the device 200, 200′ obtains at least the segmentation information SGI and the subset of data to be processed USS provided by the segmentation method according to the invention. Advantageously, it also obtains modified weight values MW intended for the processing device PROC1, PROC1′.

It should be noted that the device 100, 100′ may or may not be integrated into the coding device 200, 200′. In the first case, the device 200, 200′ directly implements the segmentation method according to the invention. In the second case, it instructs the device 100, 100′ to segment the input data and receives the segmented data in response.

In 72, the device 200, 200′ codes the data obtained SGI, USS in a conventional manner, known per se. In 73, the coded data are stored in memory M2 in a data file FD or transmitted in a data stream STR to an item of remote equipment, for example the item of terminal equipment UE, UE′ of FIGS. 4 and 5.

In relation to FIG. 8, an example of implementing a method for decoding data acquired by a plurality of sensors according to one embodiment of the invention is now presented in the form of a flowchart.

Advantageously, this method is implemented by the above-mentioned device 300 or 300′.

In 80, the coded data are obtained, for example, from a memory M3, or they are received via a communication network, such as the network RC of FIGS. 4 and 5.

According to the invention, the coded data comprises at least the segmentation information SGI and the subset of data to be processed USS, the segmentation information SGI identifying the data to be processed of the subset USS in the N sequences of input data expected by the decoder.

In 81, the coded data are decoded in a manner known per se. A subset of decoded data to be processed USSD and decoded segmentation information SGID are obtained. Optionally, in a particular embodiment, decoded modified processing weight values MWD intended for the processing device PROC2 (resp. PROC2′) are also obtained.

In 82, the decoded segmentation information SGID and the subset of decoded data to be processed USSD are used to construct sequences of segmented decoded data SQ1DS(t), SQ2DS(t), . . . , SQNDS(t) to be presented to the processing device PROC2, PROC2′. If decoded modified weight values MWD have been obtained, they are previously applied to a processing device PROC2, PROC2′ whose structure and initial configuration are similar to those of the processing device PROC1, PROC1′ on the encoder side. Once the configuration is done, the segmented decoded data sequences SQ1DS(t), SQ2DS(t), . . . , SONDS(t) are provided to the device PROC2, PROC2′ for processing.

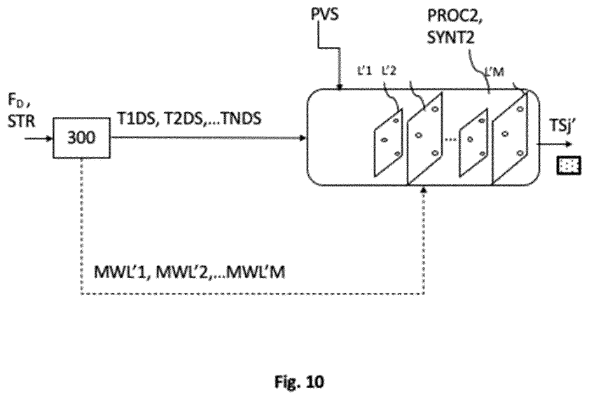

A first embodiment of the invention is now described in relation to FIGS. 9 and 10.

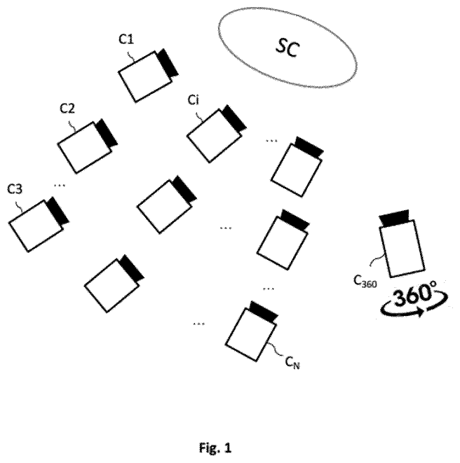

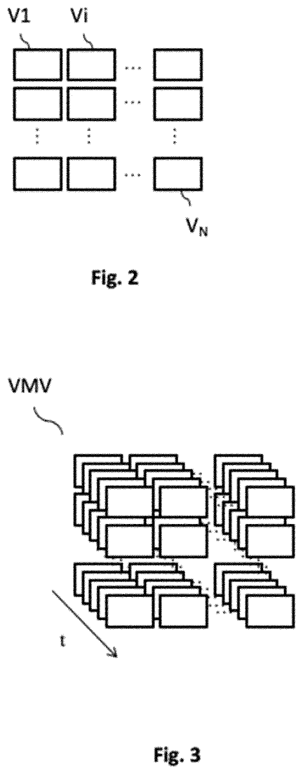

As in FIGS. 1 and 4, a scene SC captured by a set of N cameras C1, C2, . . . , CN is considered. Each camera observes the scene from a given viewpoint and generates at Nt successive times t a texture image or view T1, T2, . . . , TN corresponding to that viewpoint.

The processing to be applied to the input data corresponds here to a view synthesis. It consists in particular in synthesising an additional view associated with an additional viewpoint PVS distinct from the N viewpoints of the N cameras. The synthesis device in question is configured to take as input all or some of the N images T1(t), T2(t), . . . , TN(t) and their intrinsic (focal length, sensor resolution, number of colour components, etc.) and extrinsic (position in space, orientation, etc.) parameters of the N cameras, as well as the coordinates of the additional viewpoint PVS of the scene, and to produce as output the additional image or view TS. In this example, it is assumed that the synthesis device SYNT1, SYNT2 comprises an IBRNet neural network. Such a network has a structure in M successive layers L′1, L′2, . . . , L′M, with M a non-zero integer, connected together so that the output of an upstream layer is presented at the input of the next downstream layer. Each layer has configuration weights WjL′i, with i an integer between 1 and M and j an integer between 1 and a number of processing weights associated with the layer i, whose values are determined during a prior learning.

In relation to FIG. 9, the operations implemented on the encoder side, that is, at the item of server equipment ES of FIG. 4, are first described. According to the invention, the automatic segmentation module SEG1 also has the structure of a layered neural network, also referred to as relevance layers, since the values of its weights are intended to indicate in fine a level of relevance or usefulness of an item of input data with a view to its subsequent processing by the synthesis device SYNT1.

According to this embodiment of the invention, the automatic segmentation module comprises as many layers L1, L2, . . . , LN as input images T1(t), T2(t), . . . , TN(t) at a given instant t. For simplicity, in the following, this given instant t is considered and the corresponding sequence of input images will be referred to as T1, T2, . . . , TN.

Advantageously, each layer Li, with i between 1 and N, has the same dimensions as the corresponding input image or view. For example, if the input images are of size W×H pixels, the layer Li is also of size W×H, that is, it comprises WxH weights, each weight being a unique multiplying coefficient of the scalar (grey level) or vector (RGB or YUV triplet) value associated with the corresponding pixel of the input image. Advantageously, the multiplying coefficient is a floating real number.

As a variant, the weights of each layer Li take binary values. If the weight bit has the value 1, the associated pixel is transmitted unchanged to the input of the processing device SYNT1, otherwise the associated pixel is not transmitted to the processing device SYNT1 or it is transmitted with a predefined value (for example, −1) to indicate that it is not useful.

The neural network of the segmentation module SEG1 is then subjected to a learning so as to assign appropriate values to the weights of these various layers in order for it to perform the expected task (here, the synthesis of an additional view) satisfactorily.

According to this embodiment of the invention, in reality, it is a neural network CRN1 combining the N layers L1, L2, . . . , LN of the segmentation module SEG1 and the M layers L′1, L′2, . . . , L′M of the processing device PROC1 which is subjected to this learning. To this end, two distinct performance criteria are used, referred to herein as loss functions. The first criterion relates to a loss associated with the task of the neural network of the synthesis device SYNT1, and measures a quality of the synthesised image and the second one relates to a loss associated with the segmentation of the input data by the neural network of the module SEG1 and measures the cumulative amplitude of the values of the weights of its layers L1, . . . , LN. A global loss function taking into account these two criteria is defined. An example is detailed below.

Concretely, the learning is similar to that described in the paper by Wang et al., already cited. Briefly, this learning works as follows: for each value j in 1, . . . , N, the combined network CRN1 is asked to generate the view Tj from the other views. Since the original view Tj associated with the viewpoint PVj is available, it is possible to assess the quality of the synthesis performed by the device PROC1, for example by calculating a difference (for example, based on the mean square error) between the synthesised view TSj and the original view Tj. This difference is then used to calculate a gradient that is backpropagated to the layer Lj of the module SEG1 in a manner known per se. It should be noted that when the synthesis device is not based on an artificial intelligence method, the calculated gradient is simply propagated in the layer Lj.

For example, the global loss function to be minimised is as follows (where ∥·∥ is the L2 norm), based on the square root of the sum of the squares of the coordinates of a vector):

$$‖ Tsj - Tj ‖ + λ \cdot ‖ PLj ‖$$

Where
λ is a parameter set by the user to determine a choice between the minimisation of the size of the segmented areas (high λ) and the view synthesis performance (low λ). It is a positive real number, which can be greater or lower than 1. PLj is a vector concatenation of the W×H weights of the N layers Li.

According to a first option, the weights of the neural network of the synthesis device SYNT1 are fixed and are not modified by the learning of the module SEG1. In other words, only the weights of the layers L1, L2, . . . , LN of the module SEG1 are optimised in the sense of the loss function.

As a variant, the weights of the network layers of the processing device SYNT1 may vary. Advantageously, they are optimised during the learning of the module SEG1, which becomes a learning of the combination of the module SEG1 and the device SYNT1. In this case, the modified values MWL′1, MWL′2, . . . , MWL′M of the processing weights of the device SYNT1 are obtained and stored for transmission, for example to the item of terminal equipment UE of FIG. 4.

Once the learning (61) is done, the segmentation information SGI of the input data T1, T2, . . . , TN is determined in 62.

According to this embodiment of the invention, each layer L1, L2, . . . , LN of the module SEG1 is transformed into a segmentation map SGI1, SGI2, . . . , SGIN of the associated view TI, T2, . . . , TN. It should be noted that in this example, a segmentation map of a given image or view is a map having the same dimensions as this image, and whose elements or pixels are assigned a first value, for example the value 1, meaning that the associated pixel in the image Tj is useful for the subsequent task of the processing device PROC1, the value 0 meaning that the associated pixel in the image Tj is not useful for this processing device.

Advantageously, when the values of the weights of the layers L1, L2, . . . , LN are floating real numbers, for example between 0 and 1, the corresponding value of the segmentation map is determined by comparing each weight with a given threshold, for example equal to 0.01. If the weight value is below this threshold, then the corresponding pixel in the segmentation map is set to 0, otherwise this pixel is set to 1.

As a variant, when the values of the weights are binary, they are copied directly into the corresponding segmentation map SGIi (the SGIi map is equal to the weight map of the layer Li).

The views T1, T2, . . . , TN are then coded (72) by the coding device 200 using the segmentation maps SG1, SG2, . . . , SGN. Advantageously, a method for coding a multiview video is used, preferably the MIV standard. As a variant, other standards can be used, such as MV-HEVC or 3D HEVC.

According to the MIV standard, at an instant t, parts of views T1(t), T2(t), . . . , TN(t), referred to as patches, are arranged in a large common image, referred to as an atlas. Typically, these parts correspond for example to the result of a prior segmentation of the views acquired by the N cameras, designed to keep only non-redundant information between views. For example, a part of an object of the scene that would be visible on a given view and that is transmitted in a patch of that view no longer needs to be transmitted in a patch of another view.

The atlases corresponding to the various instants of the video are then coded as conventional 2D videos, using for example the HEVC video coding standard. The MIV standard indeed provides a syntax that enables the decoder to identify the patches within the atlases and rearrange them in the initial views. The decoded and then reconstructed views on the decoder side are therefore partial.

According to the invention, the division into patches is performed for each view Tj based on the segmentation map SGIj produced from the values assigned to the weights of the automatic segmentation module after the learning (61).

In this respect, it should be noted that there are several ways of creating patches from the same segmentation map. For example, as many patches as there are groups of connected pixels having the “useful” value in the segmentation map considered are formed. As a variant, a minimum limit can be imposed for forming a patch from such a group of connected pixels. For example, if a group of segmented pixels contains a number of pixels below a first threshold (for example equal to 100 pixels), it will not be taken into account to form a new patch, but it will be sought to attach it to a group of neighbouring segmented pixels until this limit is exceeded. According to another variant, it is also possible to simply omit taking into account the groups of segmented pixels whose number of pixels is below a second threshold, below the first one, and for example equal to 5.

The patches thus formed for a given view Ti(t) are incorporated into an atlas with other patches possibly originating from other views Tj(t) associated with the same instant t. In order to reconstitute the partial views on the decoder side, the following information must be transmitted to it, and therefore coded:
the view with which the patch is associated,
the coordinates of the patch in the atlas,
an occupancy map of the patch in the atlas.

It should be noted that the MIV standard already allows the view segmentation maps to be taken into account in the coding scheme of a multiview video so that only the input data of the subset of data to be processed USS are coded and transmitted to a receiver (UE).

Once the atlases have been filled with all the patches identified in all views, the atlases are coded by a conventional encoder, for example compliant with the HEVC standard.

In one embodiment, the configuration of the neural network of the synthesis device SYNT1 is fixed.

In another embodiment, the configuration of the neural network of the synthesis device SYNT1 is modified by the learning 61 and the modified values MWL′1, MWL′2, . . . , MWL′N of the processing weights of the various layers L′1, L′2, . . . , L′M of the neural network of the synthesis device SYNT 1 which are also coded (for example with the MPEG NNR (Neural Net Representation) coding standard), specified in part 17 of the MPEG-7 standard for their transmission to the corresponding synthesis device SYNT2 on the receiver side (UE). It should be noted here that several modified processing weight values MWL′i can be transmitted for the layer L′i and that this set of values MWL′i can take the form of a map or an image whose dimensions are identical to those of the layer L′i concerned.

It is assumed that the coded data are transmitted to an item of receiver equipment, for example the item of terminal equipment UE of FIG. 4, via the communication network RC, for example in the form of a coded data stream STR or a coded data file FD.

They are received by the decoding device 300 which, according to this embodiment, decodes the coded data relating to the complete or partial views T1, T2, . . . , TN in accordance with the MIV standard.

This decoding produces the following decoded data:
a series or sequence of atlases,
for each atlas, data representative of the patches it contains and, for each of these patches:
the view with which the patch is associated,
the coordinates of the patch in the atlas, and
an occupancy map of the patch in the atlas.

From this decoded data, the segmented decoded views T1DS, T2DS, . . . , TNDS are reconstructed (82), either completely or partially (depending on the information contained in the patches).

In the embodiment according to which modified weight values MWL′1, MWL′2, . . . , MWL′M are coded, they are also decoded and then used to update the configuration of the layers of the neural network of the processing device SYNT2.

The N decoded views T1DS, T2DS, . . . , TNDS are then presented to the neural network corresponding to the device PROC2.

It is assumed that a user UT wants to synthesise an additional view according to the additional viewpoint PVS. In this case, according to the invention, the segmented decoded views T1DS, T2DS, . . . , TNDS are presented at the input of the synthesis device SYNT2 (some layers L′i of which may have been updated with the modified decoded weight values MWL′1, MWL′2, . . . , MWL′M), according to the embodiment considered. The coordinates of the viewpoint PVS wanted by the user UT are also entered. The device SYNT2 finally produces the additional synthesised view TSj′.

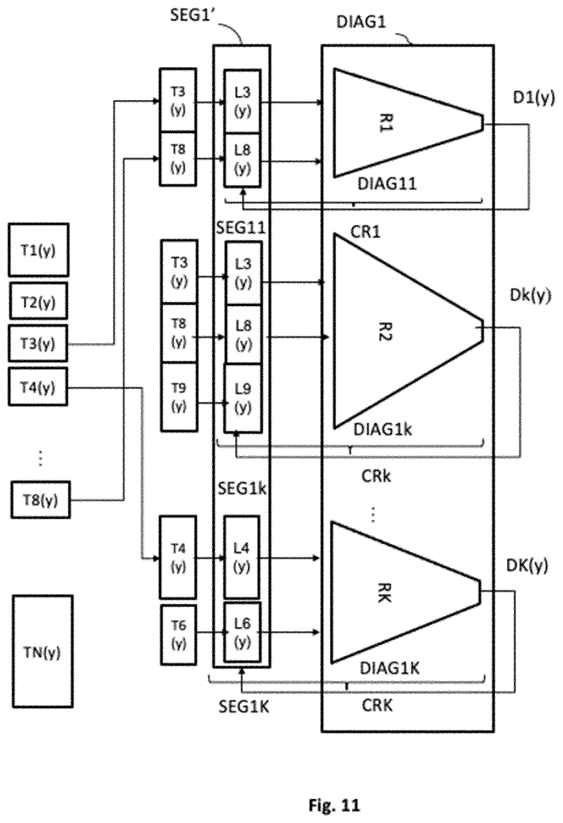

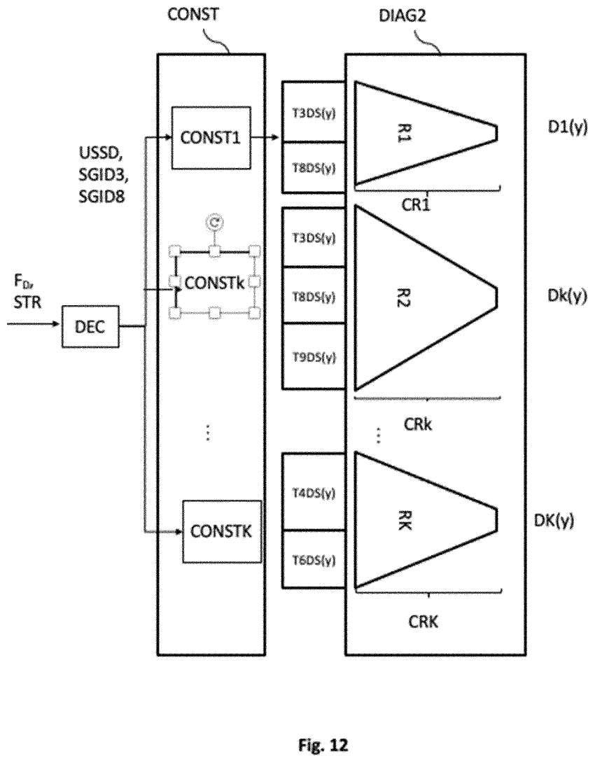

A second embodiment of the invention is now described in relation to FIGS. 11 and 12.

In relation to FIGS. 5 and 11, a patient SB surrounded by a plurality of sensors S1, S2, . . . , Si, . . . , SN of various types (ECG, EEG, scanner, MRI, chemical analyses, radio, . . . ) is considered. Each sensor acquires at least one item of data T1(Y), T2(Y), . . . , Ti(Y), . . . , TN(Y) of the physiological measurement, image, etc. type.

In addition, it is assumed that this data are then processed by several neural networks R1, R2, . . . , Rk, . . . , RK, with K a non-zero integer less than or equal to N, each specialised in a diagnosis or diagnosis assistance task. For example, all these networks are considered to form the processing device DIAG1 of FIG. 5. These networks are each configured to take as input a subset of the N input data T1(Y), . . . , Ti(y), . . . , TN(Y) and to produce as output an item of diagnosis information Di(Y) (for example, presence of a tumour, suspected epilepsy, . . . ) or an item of diagnosis assistance information (for example, a segmentation, that is, a geographical delimitation of an area likely to contain a tumour, etc.). The subset of input data to be presented to each neural network Rk is selected by an algorithm external to the neural network considered and may comprise some or all of the data Ti(Y). Examples of neural networks Rk adapted to the diagnosis of specific pathologies are given in the paper by Zhang et al, entitled “Multi-channel deep convolutional neural networks for multi-classifying thyroid disease”, published by the site https://arxiv.org/abs/2203.03627, in March 2022, in the paper by Dehghani et al, entitled “Joint brain tumor segmentation from multi MR sequences through a deep convolutional neural network”, published by the site https://arxiv.org/abs/2203.03338, in March 2022, and in the paper by Salafian et al, entitled “CNN-Aided Factor Graphs with Estimated Mutual Information Features for Seizure Detection”, published by the site https://arxiv.org/abs/2203.05950 in March 2022.

The processing to be applied to the input data of each of the networks Rk therefore corresponds here to a diagnosis assistance processing.

In this example, it is assumed that each processing device DIAG11, DIAG12, . . . , DIAG1K comprises a neural network in layers R1, R2, . . . , RK. Each of these networks Rk has a structure in successive layers, connected together so that the output of an upstream layer is presented at the input of the next downstream layer. Each layer has configuration weights whose values are adjusted during a prior learning.

In relation to FIG. 11, the operations implemented on the encoder side, that is, at the item of server equipment ES' of FIG. 5, are first described. In this example, K segmentation modules SEG11′, SEG1k′, . . . , SEG1K′ are considered, each having the structure of a neural network in layers, or relevance layers, since the values of its weights are intended to indicate in fine a level of relevance or usefulness of an item of input data with a view to its subsequent processing by the neural network R1, R2, . . . , RK corresponding to the processing device DIAG11, DIAG1k, . . . , DIAG1K concerned.

According to this embodiment of the invention, each segmentation module SEG1k′ comprises as many layers L1, L2, . . . , LN as input data intended for the network Rk. According to a variant not shown, the segmentation layers can be pooled so that the segmentation module SEG1 has one layer Li per type of item of input data Ti and that the corresponding segmented data are sent to each of the networks Rk that need them. For example, in FIG. 11, the network Rk, which receives the data T3, T8 and T9, is connected at the input to the layers L3(y), L8(y) and L9(y).

Advantageously, each layer Lik(y) of the module SEG1k′ has the same size as the associated item of input data. For example, if the input data are of size H parameters, the layer Li(y) is also of size H weights, each weight being a unique multiplying coefficient associated with an item of data (this item of data having, for example, a scalar or vector value).

In a particular embodiment, the weights of each layer Lik(y) of the segmentation module SEG1k′ take binary values. If the weight bit has a value of 1, the associated item of data or parameter is transmitted to the network Rk, otherwise it is not transmitted. It should be noted that, in the latter case, a predefined value (for example equal to −1) is transmitted to the processing device DIAG1k.

According to the invention, a learning of the networks combining a certain number of layers Li(Y) and the layers (not show) of the networks Rk is performed, using a loss function that combines the loss linked to the task of the networks Rk (that is, the diagnosis quality) and a loss representative of the cumulative amplitude of the weights of the layers Ci(Y). CRk refers to the network obtained by combining the input layer(s) Li(Y) with the network Rk. Before this learning of the networks of the segmentation modules SEG1k′, the sequence of input data T1(y), T2(y) . . . (TN(y) is presented to each of the networks Rk so as to obtain original diagnoses Dk(y).

The learning, which is known per se, then works as follows. For each value k in 1, . . . , K, it will be tried to maximise the diagnosis capacity of the network CRk based on the data. Since the original diagnosis Dk(y) is available, it is possible to calculate a difference between this original diagnosis and the output of the network CRk (for example, the diagnosis digital error). This difference is used to calculate a gradient that is backpropagated to the weights of the combined network CRk to be optimised, according to the known formula.

Hereinafter, Destk refers to the value of the diagnosis generated by CRk(Y) and Dk(y) to the original diagnosis. The loss function to be minimised (where ∥·∥ is the L2 norm) can be expressed as follows:

$$‖ Destk - Dk ( y ) ‖ + λ \cdot ‖ Pli ‖$$

Where
λ is a parameter set by the user for determining a choice between the minimisation of the size of the segmented zones (high λ) and the diagnosis performance (low λ) and λPLi is a vector concatenation of the weights of K layers Li present in the neural network of the segmentation module SEG1k′ at the input of the processing device DIAG1k. These are positive real numbers that can be greater or less than 1.

In a first embodiment, the weights of the network Rk contained in the neural network CRk are fixed during the learning, only the weights of the layers Li of the network of the segmentation module SEG1k′ are optimised in the sense of the loss function explained above.

In a second embodiment, the weights of the layers of the network Rk are also modified by the learning. Their modified values (not shown) are stored in memory.

Each layer Lik of the network SEG1k′ resulting from the learning is then transformed into a segmentation map SGIi of the associated data. A segmentation map is a map of the same size as the data, containing for each parameter in the item of data the value 0 or 1, 0 meaning that the associated parameter in the item of data is not used for the subsequent diagnosis task, and 1 meaning the opposite.

Advantageously, when the values of the weights of the layers Li are floating real numbers, for example between 0 and 1, the corresponding value of the segmentation map is determined by comparing each weight with a given threshold, for example equal to 0.01. If the value of the weight is below this threshold, then the corresponding item of data of the segmentation map is set to 0, otherwise it is set to 1.

As a variant, when the values of the weights are binary, they are copied directly into the corresponding segmentation map SGIi (the SGIi map is equal to the weight map of the layer Ci).

The segmented parts of the input data T1(y), T2(y), . . . , TN(y) are then coded, that is, the set of data to be processed USS obtained by applying the segmentation maps SGIi obtained at each of the N sequences of input data. For example, a standard such as MPEG NNR or gzip is used.

It is also necessary to code the segmentation map, for example in the form of a series of binary values indicating for each parameter or measurement of the sequence Ti considered whether or not it is coded.

The coded data are stored in memory and/or transmitted in a data file or a data stream.

In relation to FIG. 12, a receiver of the coded data stream STR or of the coded data file FD is now considered, for example the item of terminal equipment UE′ of FIG. 5, said receiver decoding the coded data received in the stream STR or in the file FD. The segmentation maps SGD1, SGD2, . . . , SGDN indicating which parameters of the N sequences T1, T2, . . . , TN have been transmitted and are therefore contained in the subset of data to be processed are decoded, and then the values of the parameters in question (contained in the coded subset of data to be processed) are decoded, using a suitable decoding method which is the reciprocal of that used during coding (MPEG NNR decoding, or gzip decoding). A decoded subset of data to be processed USSD is obtained.

The segmented decoded data sequences T1DS, T2DS, . . . , TNDS are then reconstructed respectively (in 82, by CONST1, CONST2, . . . , CONSTK) for each of the diagnosis devices DIAG21, DIAG22, . . . , DIAG2K, whether they are complete (all the parameters of the data sequence can be reconstructed) or partial (the transmitted parameters allow only part of the sequence to be reconstructed) from the decoded subset of data to be processed USSD and the decoded segmentation maps SGD1, SGD2, . . . , SGDK. Optionally, when the decoded data comprise modified weight values for the networks Rk, these modified weight values are injected into the networks Rk concerned.

A diagnosis assistance processing is now performed using the device DIAG2 of FIG. 5. In this example, a user (here, a practitioner) wants to perform a diagnosis using a network Rk of FIG. 11, for example the network R2, and some of the reconstructed data sequences, for example T3D, T8D and T9D. The segmented data T1DS, T2DS, . . . , TNDS reconstructed during decoding (possibly partial) are entered into the layers Ci, that are themselves connected to the input of the network CRk of the device DIAG2k. The network Rk can then produce its diagnosis from the segmented data alone.

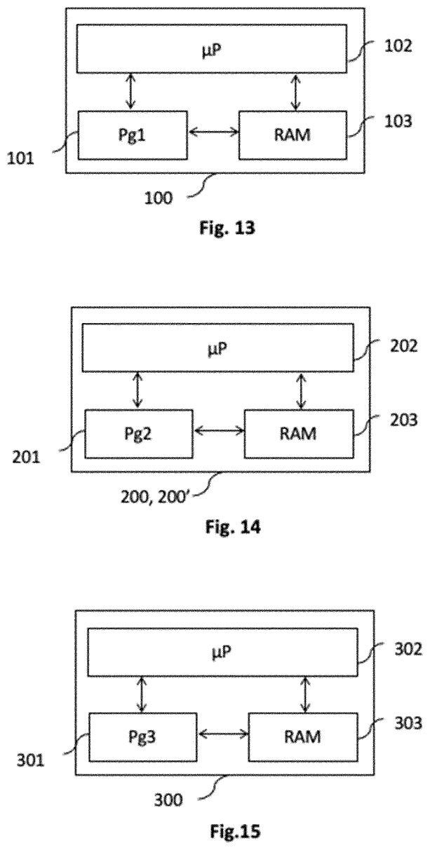

In relation to FIG. 13, an example of the hardware structure of a device 100 for segmenting a plurality of input data acquired by sensors, comprising a module for determining weight values to be applied to the plurality of input data before it is processed by at least one processing device configured to produce a processing result according to a criterion for maximising a quality measurement of the input data processing result, said weight values being determined depending on said criterion and on another criterion for minimising a quantity of input data to be processed, a module for determining segmentation information of said plurality of input data, one said item of segmentation information of one said item of data being assigned a first value or a second value distinct from the first one, depending on said weights, and a module for obtaining a subset of data to be processed by applying the determined segmentation information to said plurality of input data, the subset of data to be processed comprising the data of the plurality of input data associated with an item of segmentation information equal to the first value.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing unit 102 equipped for example with a processor and controlled by a computer program Pg1, representative of the modules of the above-mentioned device 100, stored in a read-only memory 101 (a ROM memory or hard disk, for example). At initialisation, the code instructions of the computer program are for example loaded into a random access memory 103 before being executed by the processor of the processing item 102. The random access memory 103 can also contain the segmentation information and the subset of useful data.

FIG. 13 only illustrates a particular one of several possible ways of realising the device 100, 100′, so that it executes the steps of the segmentation method as detailed above, in relation to FIGS. 6, 9 and 11 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

In relation to FIG. 14, an example of the hardware structure of a device 200, 200′ for coding a plurality of input data according to the invention, comprising at least a module for obtaining segmentation information of the plurality of input data and a subset of data to be processed by applying said segmentation information to the plurality of input data, said segmentation comprising the determination of weight values to be applied to the plurality of input data before it is processed by at least one processing device previously configured to produce a processing result depending on a criterion for maximising a quality measurement of the processing, said weight values being determined depending on said criterion and on another criterion for minimising a quantity of input data to be processed, one said item of information of one said item of data being assigned a first or a second value distinct from the first one, depending on said weight values, the subset of data to be processed comprising the data of the plurality of input data associated with an item of segmentation information equal to the first value, and a module for coding the segmentation information and the subset of data to be processed.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200, 200′ comprises a random access memory 203 (for example, a RAM memory), a processing unit 202 equipped for example with a processor and controlled by a computer program Pg2, representative of the segmentation and coding modules stored in a read-only memory 201 (for example, a ROM memory or hard disk). At initialisation, the code instructions of the computer program are for example loaded into a random access memory 203 before being executed by the processor of the processing item 202. The random access memory 203 can also contain the coded information.

FIG. 14 only illustrates a particular one of several possible ways of realising the device 200, 200′, so that it executes the steps of the coding method as detailed above, in relation to FIGS. 7, 9 and 11 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200, 200′ is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

Finally, in relation to FIG. 15, an example of the hardware structure of a device 300, 300′ for decoding coded data, comprising a module for decoding coded data comprising segmentation information of a plurality of data acquired by sensors, referred to as input data, and a subset of data to be processed, one said item of segmentation information of one said item of input data being assigned a first value or a second value distinct from the first one, said subset of data to be processed having been obtained by applying said segmentation information to the plurality of input data, the subset of data to be processed comprising the data of the plurality of input data associated with one said item of segmentation information equal to the first value, a module for constructing a plurality of decoded segmented input data from the subset of decoded data to be processed and the decoded segmentation information, and a module for providing the plurality of decoded segmented input data to a processing device configured to produce a processing result depending on a criterion for maximising a quality measurement of the processing.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 300, 300′ comprises a random access memory 303 (for example, a RAM memory), a processing unit 302 equipped for example with a processor and controlled by a computer program Pg3, representative of the above-mentioned modules, stored in a read-only memory 301 (for example, a ROM memory or hard disk). At initialisation, the code instructions of the computer program are for example loaded into a random access memory 303 before being executed by the processor of the processing item 302.

FIG. 15 only illustrates a particular one of several possible ways of realising the device 300, 300′, so that it executes the steps of the decoding method as detailed above, in relation to FIGS. 8, 10 and 12 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 300, 300′ is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The invention that has just been described in its different embodiments has many advantages. It makes it possible to select, from a plurality of data representative of a scene, an object or a subject, before it is transmitted in a communication network, those that will actually be useful for the processing of this plurality of data by a processing device of an item of receiver equipment. To this end, the invention uses machine learning techniques, which it implements in a clever way to train specifically at an item of transmitter equipment an automatic segmentation module to segment the plurality of input data so as to minimise the quantity of data to be transmitted while maximising the quality of the processing.

1. A method for segmenting a plurality of data acquired by sensors, referred to as input data, said method being implemented by a segmenting device and comprising:
determining weight values to be applied to the plurality of input data before the input data is processed by at least one processing device configured to produce a processing result according to a criterion for optimising a quality of the input data processing result, said weight values being determined depending on said criterion and on another criterion for optimising a quantity of input data to be processed,
determining segmentation information of said plurality of input data, an item of the segmentation information of an item of the data of the plurality of input data being assigned a first value or a second value distinct from the first value, depending on said weight values, and
obtaining a subset of data to be processed by applying the determined segmentation information to said plurality of input data, the subset of data to be processed comprising the data of the plurality of input data associated with an item of segmentation information equal to the first value.

2. The method according to claim 1, the determining the weight values comprises learning said weight values from said plurality of input data, said learning being performed by backpropagation of a gradient of a loss function combining the criterion for optimising the quality and the other criterion for optimising the quantity.

3. The method according to claim 1, wherein said processing device comprises weights, referred to as processing weights, values of said processing weights having been previously determined depending on the criterion for optimising the quality of the input data processing result, and wherein the method further comprises determining (64) modified values of said processing weights.

4. The according to claim 1, wherein said plurality of input data comprises a plurality of views acquired by a plurality of cameras, one said views comprising pixels, said weight values being comprised in a plurality of layers, one said layer is associated with one said view and comprising one said weight per pixel, and wherein the segmentation information comprises a plurality of segmentation maps, one said map being associated with one said view.

5. The method for segmenting a plurality of data according to claim 1, wherein said plurality of input data comprises a plurality of sequences of measurement data acquired by a plurality of sensors, said weight values being comprised in a plurality of layers, one said layer being associated with one said sequence of measurement data and comprising one said weight per item of measurement data and wherein the segmentation information comprises a plurality of segmentation sequences, one said segmentation sequence being associated with one said sequence of measurement data.

6. A method for coding a plurality of data acquired by sensors, referred to as input data, wherein the method is implemented by a coding device and comprises:
obtaining segmentation information of the plurality of input data and a subset of data to be processed by applying said segmentation information to the plurality of input data, said segmentation having been determined by determining weight values to be applied to the plurality of input data before the input data is processed by at least one processing device previously configured to produce a processing result depending on a criterion for optimising a quality of the processing, said weight values being determined depending on said criterion and on a criterion for optimising a quantity of input data to be processed, an item of the segmentation information of an item of the data of the plurality of input data being assigned a first or a second value distinct from the first value, depending on said weight values, the subset of data to be processed comprising the data of the plurality of input data associated with an item of the segmentation information equal to the first value, and
coding the segmentation information and the subset of data to be processed.

7. The method according to claim 6, wherein the obtaining further comprises:
obtaining modified weight values, said modified weight values being intended to be applied to the input data by the processing device, said modified weight values previously determined depending on said criterion for optimising the quality of the input data processing result and for processing the plurality of input data, having been modified depending on said criteria, for processing the subset of data to be processed,
coding said modified weight values.

8. A method for decoding coded data, wherein the method is implemented by a decoding device and comprises:
decoding coded data, said coded data comprising segmentation information of a plurality of data acquired by sensors, referred to as input data, to produce decoded segmentation information and a subset of decoded data to be processed by a processing device configured to apply weights to the plurality of input data and to produce a processing result depending on a criterion for optimising a quality of the processing, one item of the segmentation information of one item of the input data being assigned a first value or a second value distinct from the first value, said subset of data to be processed having been obtained by applying said segmentation information to the plurality of input data, the subset of data to be processed comprising the data of the plurality of input data associated with an item of the segmentation information equal to the first value, said coded data further comprising modified values of said weights, said modified values having been determined for processing the plurality of segmented input data, depending on the criterion for optimising a quality of the processing and on a criterion for optimising a quantity of data of the subset of data to be processed,
constructing a plurality of decoded segmented input data from the subset of decoded data to be processed and the decoded segmentation information, and
providing the plurality of decoded segmented input data and the modified values of said weights to the processing device.

9. (canceled)

10. A segmenting device for segmenting a plurality of data acquired by sensors, referred to as input data, said segmenting device comprising:
at least one processor; and
at least one non-transitory computer readable medium comprising instructions stored thereon which when executed by the at least one processor configure the segmenting device to implement:
determining weight values to be applied to the plurality of input data before the input data is processed by at least one processing device configured to produce a processing result according to a criterion for optimising a quality of the input data processing result, said weight values being determined depending on said criterion and on a criterion for optimising a quantity of input data to be processed,
determining segmentation information of said plurality of input data, an item of the segmentation information of an item of the data of the plurality of input data being assigned a first value or a second value distinct from the first value, depending on said weight values, and
obtaining a subset of data to be processed by applying the determined segmentation information to said plurality of input data, the subset of data to be processed comprising the data of the plurality of input data associated with an item of segmentation information equal to the first value.

11. A coding device for coding a plurality of data acquired by sensors, referred to as input data, said coding device comprising:
at least one processor; and
at least one non-transitory computer readable medium comprising instructions stored thereon which when executed by the at least one processor configure the coding device to implement:
obtaining segmentation information of the plurality of input data and a subset of data to be processed by applying said segmentation information to the plurality of input data, said segmentation having been determined by determining weight values to be applied to the plurality of input data before the input data is processed by at least one processing device previously configured to produce a processing result depending on a criterion for optimising a quality of the processing, said weight values being determined depending on said criterion and on another criterion for optimising a quantity of input data to be processed, an item of the segmentation information of an item of the data of the plurality of input data being assigned a first or a second value distinct from the first value, depending on said weight values, the subset of data to be processed comprising the data of the plurality of input data associated with an item of the segmentation information equal to the first value, and
coding the segmentation information and the subset of data to be processed.

12. A decoding device for decoding coded data, wherein the decoding device comprises:
at least one processor; and
at least one non-transitory computer readable medium comprising instructions stored thereon which when executed by the at least one processor configure the decoding device to implement:
decoding coded data, said coded data comprising segmentation information of a plurality of data acquired by sensors, referred to as input data, to produce decoded segmentation information and a subset decoded data to be processed by a processing device configured to apply weights to the plurality of input data and to produce a processing result depending on a criterion for optimising a quality of the processing, an item of the segmentation information of an item of the input data being assigned a first value or a second value distinct from the first value, said subset of data to be processed having been obtained by applying said segmentation information to the plurality of input data, the subset of data to be processed comprising the data of the plurality of input data associated with an item the of segmentation information equal to the first value, said coded data further comprising modified values of said weights, said modified values having been determined for processing the plurality of segmented input data, depending on the criterion for optimising a quality of the processing and on a criterion for optimising a quantity of data of the subset of data to be processed,
constructing a plurality of decoded segmented input data from the subset of decoded data to be processed and the decoded segmentation information, and
providing the plurality of decoded segmented input data and the modified values of said weights to the processing device.

13. (canceled)

14. A non-transitory computer-readable medium comprising a computer program product stored thereon and comprising program code instructions for implementing the method according to claim 1, when the instructions are executed by a processor of the segmenting device.

15. A non-transitory computer-readable medium comprising a computer program product stored thereon and comprising program code instructions for implementing the method according to claim 6, when the instructions are executed by a processor of the coding device.

16. A non-transitory computer-readable medium comprising a computer program product stored thereon and comprising program code instructions for implementing the method according to claim 8, when the instructions are executed by a processor of the decoding device.
